(19) United States
(12) Patent Application Publication
(10) Pub. No.: US 2025/0175550 A1
(43) Pub. Date: May 29, 2025

(54) MULTI-FUNCTIONAL ACCESSORY FOR MOBILE DEVICE

(71) Applicant: CASE-MATE, INC., Atlanta, GA (US)

(72) Inventors: Andrew HARPER, Lilburn, GA (US); Cole David DOBSON, Atlanta, GA (US); Jonathan Asher RUBY, Sandy Springs, GA (US)

(21) Appl. No.: 18/522,972

(22) Filed: Nov. 29, 2023

(51) Int. Cl. H04M 1/21

(52) U.S. Cl. CPC H04M 1/21

(57) ABSTRACT

A multi-function accessory for use with a mobile device includes an attachment portion and a support portion pivotally connected to the attachment portion. One or more magnets may provide removable attachment to the mobile device. When attached to the mobile device, the accessory may serve as a grip or stand for the object and may also be used as a bottle opener.

### TECHNICAL FIELD

The present invention relates generally to the field of accessories for mobile devices, and more particularly to a multi-functional magnetic multi-tool accessory for use with a mobile device such as a mobile phone or tablet computer.

### BACKGROUND

Often, users of mobile devices such as a mobile phone or tablet computer may wish to achieve a better grip on the device through the use of an external accessory. Mobile device users may also wish to support a mobile on a surface at a particular viewing angle when looking at the mobile device for long periods of time, such as when watching a movie or on a videoconference. In many cases, previously known devices for supporting a phone may only accomplish one of these tasks or may be limited in use to certain orientations of the device. Additionally, some previous accessories may be difficult to remove and reattach to the mobile device, and/or may have a weaker attachment with the device than would be desired, any of which may prevent the accessory from being used for additional functions or from being placed in alternative orientations.

It is also the case that people sometimes prefer accessories to serve multiple functions. For example, people commonly need bottle openers to open beverages, but may not always have a bottle opener readily available. Some previously known bottle openers are configured to be carried on a keyring. However, with the widespread adoption of keyless actuators and locking devices, more and more people are forgoing keys and are instead relying on mobile devices to operate locks and other equipment. As a result, many people no longer carry keys, and therefore no longer carry the bottle opening devices that may previously have been carried on the associated keyrings.

Accordingly, it has been found that needs exist for a multi-tool accessory for a mobile device capable of providing a grip, a stand, and a bottle opener functionality, and that can easily and securely be attached to and detached from a mobile device. It is to the provision of a multi-functional magnetic multi-tool for use with a mobile-device meeting these and other needs that the present invention is primarily directed.

### SUMMARY

In example embodiments, the present invention provides multi-functional magnetic multi-tool accessory for use with a mobile device such as a mobile phone, tablet computer, or other mobile electronic device. In example embodiments, the multi-tool or multi-functional accessory comprises a first generally annular body or attachment portion configured for attachment to the mobile device, and a second generally annular body or support portion pivotally attached to the attachment portion and configured for supporting the electronic device when placed on a support surface or hand-held by a user. In some example embodiments, the attachment portion has an inner dimension that is generally larger than an outer dimension of the support portion, allowing the bodies to pivot between a closed configuration wherein the bodies are generally concentric and nested with one another and one or more open configurations wherein the bodies are generally non-concentric and extended relative to one another. The attachment portion may further comprise one or more magnets and a surface having an opening. The magnet(s) within the multi-tool accessory allow it to be magnetically and removably attached to other objects, such as mobile devices and/or cases capable of receiving magnetic attachments.

The multi-tool or multi-functional accessory is configured to perform various functions. For example, a user may use the multi-tool as a grip when attached to an object, such as a mobile phone, tablet or other mobile device. To do so, the multi-tool is placed in an open configuration wherein the support portion is extended at an angle relative to the attachment portion which is attached to the mobile device. A user may then grasp the support portion and/or place a finger through an opening therein to gain a better grip or hold upon the attached mobile device.

The multi-tool or multi-functional accessory may also be used as a stand for a mobile device. To do so, the user attaches the attachment portion of the multi-tool accessory to a mobile device and/or case. With the multi-tool accessory in an open configuration with the support portion extended from the attachment portion, the mobile device and/or case are set on their edge on a support surface and angled such that the support portion contacts the surface and supports the mobile device in a desired position for use. The angle of the support portion relative to the mobile device and/or case can be adjusted so as to adjust the viewing or support angle of the mobile device and/or case relative to the surface.

The multi-tool or multi-functional accessory may also be used as a bottle opener. To open a bottle with the multi-tool, a portion of the accessory, for example a tab or flange extending inwardly from a central opening or channel within the attachment portion of the accessory, is placed such that it is partially between the lip at the opening of a bottle and its bottle cap. When sufficient twisting or prying force is applied to the multi-tool accessory by a user, the bottle cap becomes dislodged from the bottle to expose the bottle opening.

In one aspect, the present invention relates to a multi-functional accessory for a mobile device. The multi-functional accessory preferably includes an attachment portion configured for removable attachment to the mobile device, a support portion pivotally coupled with the attachment portion, and a bottle opener portion.

In another aspect, the present invention relates to a multi-functional accessory for a mobile device. The multi-functional accessory preferably includes an attachment portion configured for removable magnetic attachment to the mobile device and having a magnetic array extending substantially continuously 360° around a base surface of the attachment portion without any non-magnetic sections. The multi-functional accessory preferably also includes a support portion pivotally coupled with the attachment portion.

In still another aspect, the present invention relates to a multi-functional

accessory for a mobile device. The multi-functional accessory preferably includes an attachment portion configured for removable attachment to the mobile device, and a support portion pivotally coupled with the attachment portion. The support portion preferably has a polygonal external periphery.

In another aspect, the present invention relates to a multi-tool or multi-functional accessory comprising a first generally annular body and a second generally annular body pivotally attached to the first annular body. One or both of the first generally annular body and second generally annular body are configured for magnetic engagement with another object. In some embodiments, the multi-tool is configured to magnetically engage a mobile device, such as a smartphone. In example embodiments, the first generally annular body has a larger inner dimension than the outer dimension of the second generally annular body. In some embodiments, one of the first generally annular body or the second generally annular body further comprises a first pivotal coupling element, and the other of the first generally annular body or the second generally annular body further comprises a connection arm or second pivotal coupling element that is configured to pivotally engage the first pivotal coupling element to form a hinged or rotational coupling or joint between the first and second generally annular bodies. In particular embodiments, the multi-tool further comprises a surface formed within the interior of at least the first generally annular body or the second generally annular body and having an opening, the surface being configured to engage a bottle cap to open bottles. In some examples, the first generally annular body and the second generally annular body can be configured so as to be generally concentric, and in some embodiments, the first generally annular body and the second generally annular body can be configured so as to be generally non-concentric. In particular embodiments, one of the first generally annular body and the second generally annular body further comprises a magnet having a continuous shape.

In another aspect, the invention relates to a multi-tool or multi-functional accessory comprising a first generally annular body further comprising a magnet and a surface formed within the interior of the first generally annular body and having opening. The multi-tool also comprises a second generally annular body pivotally attached to the first generally annular body. The second generally annular body is sized so as to fit within the first generally annular body and configured to pivot between being generally concentric and generally non-concentric with the first generally annular body. In some embodiments, the second generally annular body is a polygonal shape, and octagonal in particular embodiments. In certain examples, the multi-tool is configured to be magnetically and removably attached to a mobile device. In some embodiments, the multi-tool may be configured such that the first generally annular body is configured to be magnetically and removably attached to the mobile device, and the second generally annular body remains pivotable between generally concentric and generally non-concentric positions with respect to the first generally annular body. In some embodiments, the multi-tool may be configured such that when the second generally annular body is generally non-concentric with the first generally annular body, the multi-tool supports the mobile device in a generally upright position when the mobile device is placed upon at least one of its sides. In certain embodiments, the multi-tool remains magnetically and removably attached to the mobile device when the multi-tool and attached mobile device are suspended by the second generally annular body. In yet further embodiments, the surface is configured to open bottles.

In still another aspect, the invention relates to a method of supporting a mobile device such as a mobile phone or tablet computer, the method comprising: magnetically and removably attaching a multi-tool or multi-functional accessory to the mobile device, the multi-tool accessory comprising a first generally annular body and a second generally annular body pivotally attached to the first generally annular body; configuring the first generally annular body and the second generally annular body such that they are generally non-concentric; placing the mobile device on its side and supported by the accessory in a desired orientation.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a multi-tool or multi-functional accessory attached to a mobile device according to an example embodiment of the present invention.

FIG. 2 is a front view of the multi-tool or multi-functional accessory of FIG. 1 in an open configuration.

FIG. 3 is a front view of the multi-tool or multi-functional accessory of FIG. 1 in a closed configuration.

FIG. 4 is a rear view of the multi-tool or multi-functional accessory of FIG. 1.

FIGS. 5A, 5B, 5C and 5D (collectively FIG. 5) are perspective views of a multi-tool or multi-functional accessory connected to a mobile device according to another example of the present invention, with each figure showing the multi-tool or multi-functional accessory connected to the device in a different orientation.

FIG. 6 is a perspective view of a multi-tool or multi-functional accessory connected to a mobile device and being held by a user, according to another example embodiment and mode of use of the present invention.

FIG. 7 is a perspective view of a multi-tool or multi-functional accessory connected to a mobile device and supporting the device upon a support surface, according to another example of the present invention.

FIGS. 8A, 8B and 8C (collectively FIG. 8) are perspective views of a multi-tool or multi-functional accessory connected to a mobile device, resting upon a support surface and supporting the device in different orientations and configurations, according to further example embodiments and modes of use of the present invention; FIG. 8A supported in a horizontal or landscape orientation at a first angle relative to a support surface, FIG. 8B supported in a horizontal or landscape orientation at a second angle relative to the support surface, and FIG. 8C supported in a vertical or portrait orientation at a third angle relative to a support surface.

FIGS. 9A and 9B (collectively FIG. 9) are perspective views of a multi-tool or multi-functional accessory being used to remove a bottle cap to open a bottle, according to a further embodiment of the present invention; FIG. 9A showing the multi-tool being used to open a bottle while in an open configuration, and FIG. 9B showing the multi-tool being used to open a bottle while in a closed configuration.

FIG. 10 is a rear view of a multi-tool or multi-functional accessory according to another example embodiment of the present invention, having an alternative magnetic attachment configuration.

FIG. 11 is a perspective view of a multi-tool or multi-functional accessory according to another example embodiment of the present invention, having an alternative support portion and body configuration.

FIG. 12 is an assembly view of a multi-tool or multi-functional accessory according to another example embodiment of the present invention, having an alternative attachment configuration.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

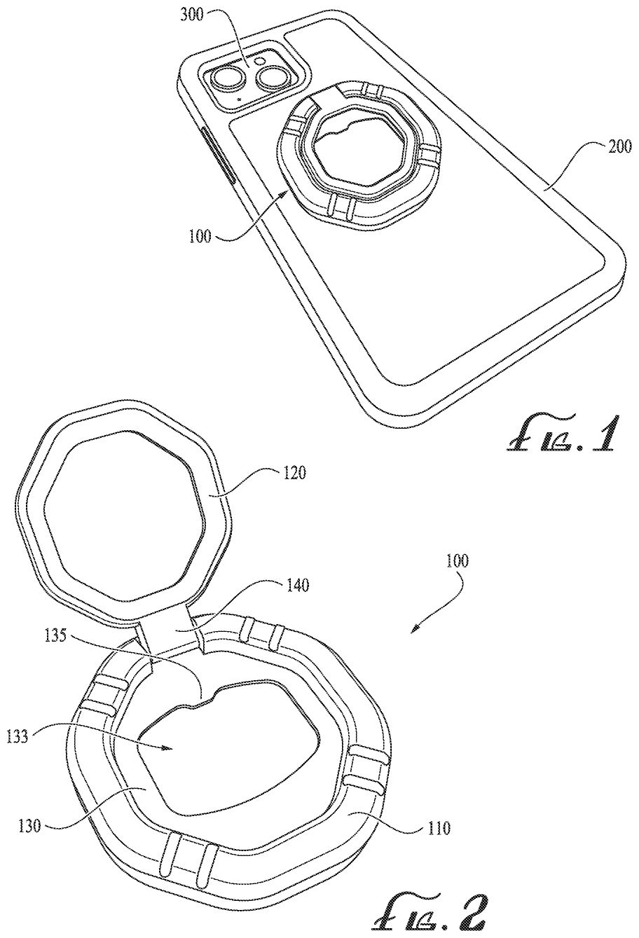

With reference now to the drawing figures, wherein like reference numbers represent corresponding parts throughout the several views, FIG. 1 shows an example multi-tool or multi-functional accessory 100 removably and magnetically attached to a case 200 surrounding a mobile device 300 in the form of a cellphone. The magnetic attraction between the multi-tool or multi-functional accessory 100 and the phone 300 and/or case 200 is strong enough that the multi-tool or multi-functional accessory remains attached when supporting the weight of the mobile device 300 and/or case 200, yet weak enough that a user may separate the multi-tool or multi-functional accessory 100 from the mobile device 300 and/or case 200 through the application of manual force. The design of the multi-tool or multi-functional accessory 100 allows it to serve multiple functions, for example as a grip, a stand, and a bottle opener.

In the example embodiment shown, the multi-tool or multi-functional accessory 100 is configured for magnetic attraction and attachment to one or more magnetic components within the mobile device 300 and/or a case 200 for a mobile device, such as for example the Apple MagSafe magnetic attachment system. The magnetic attraction between the multi-tool or multi-functional accessory 100 and the mobile device 300 causes the multi-tool or multi-functional accessory 100 to become securely but removably affixed, and therefore removably attached, to the surface of the case 200 or phone 300. In some embodiments, the case 200 is removed from the phone 300, and the multi-tool or multi-functional accessory 100 is removably attached directly to the phone 300. In other embodiments, the case 200 additionally or alternatively comprises one or more magnetic components that magnetically attract the multi-tool or multi-functional accessory 100 such that the multi-tool or multi-functional accessory 100 becomes removably attached to the case 200. In alternate embodiments, the multi-functional accessory may be attached to a mobile device or case for a mobile device by other or additional attachment means such as hook-and-loop fasteners, releasable adhesive, detachable clips or other couplings, interengaging friction-fit elements, other magnetic arrangements, or the like.

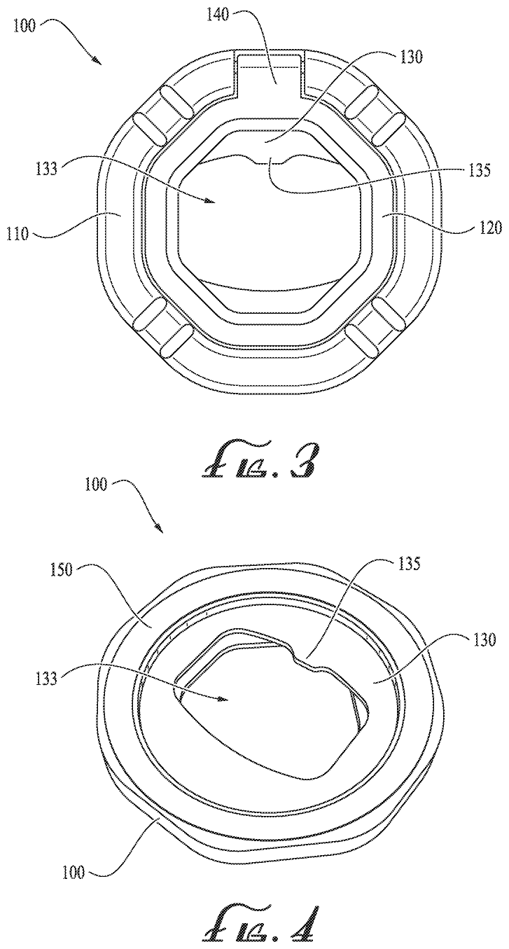

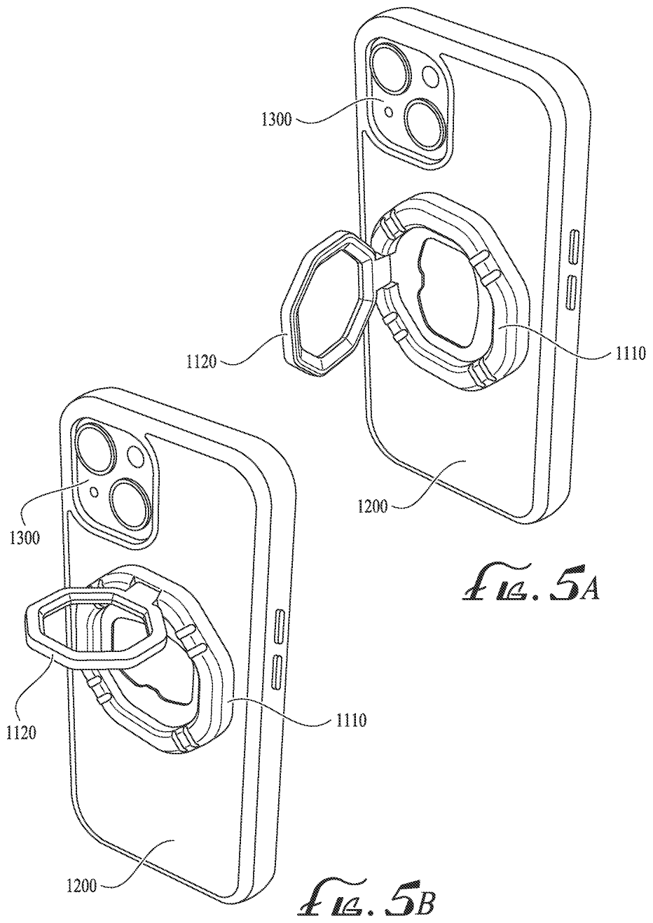

FIGS. 2-4 show the multi-tool or multi-functional accessory 100 of FIG. 1 in greater detail. In the example embodiment shown, the multi-tool or multi-functional accessory 100 is further comprised of a first generally annular body or attachment portion 110 and a second generally annular body or support portion 120 pivotally or hingedly attached to the first generally annular body or attachment portion 110. In the embodiment shown, the attachment portion further comprises surface 130 having an opening or slot 133 formed in a center portion thereof and a lip or flange 135 extending inwardly into the opening or slot. The attachment portion 110 also comprises a pivot or hinge pin, and a magnet 150. In some example embodiments, the magnet 150 comprises a full circular or ring-shaped magnet array, extending substantially continuously 360° around the proximal base or back surface of the attachment portion 110, without any cut away or non-magnetic sections, as shown in FIG. 4, for improved magnetic attachment to the phone or case. In alternate embodiments, the magnet may be otherwise configured, for example having a C-shaped configuration as shown in FIG. 10, with one or more magnetic segments 150′ of the accessory 100′ and one or more cut-away or non-magnetic areas 155′. The polarity of the magnetic ring 150, or segments of the magnetic ring may be configured in an array for cooperative engagement with a corresponding magnetic attachment portion of the mobile device to which the accessory is intended for attachment and use with.

In the example embodiments depicted, the support portion 120 further comprises a connection arm 140 extending toward the attachment portion 110 and pivotally connected to the pivot or hinge pin, thus allowing the attachment portion and the support portion to pivot relative to one another. In other embodiments, the support portion may comprise a pivot or hinge pin, and the attachment portion may comprise a pivot arm. In yet further embodiments both the attachment portion and the support portion may comprise a pivot or hinge pin, and the connection arm may extend between the two pivots. The pivot or hinge coupling between the attachment portion 110 and the support portion 120 may be freely or loosely rotating, or in alternate embodiments may provide frictional or indexed rotation for selective positioning and positional retention of the accessory in one or more desired configurations.

In example embodiments, the support portion 120 is sized and shaped so that it fits nestingly and generally concentrically within a recess formed in the attachment portion 110. For example, in the embodiment shown in FIGS. 1-4, the attachment portion 110 comprises an interior recess in its distal or exterior surface with an inner dimension larger than the corresponding outer dimension of the support portion 120. Thus, the attachment portion 110 and the support portion 120 can pivot between one or more generally non-concentric open or extended configurations (as shown in FIG. 2) and a generally concentric and nested closed configuration (as shown in FIG. 3). In particular embodiments, the range of pivotal motion of the support portion 120 relative to the attachment portion 100 spans from about 0° (closed) to at least about 90° (open or extended), for example to about 130° or about 140°. Furthermore, friction or indexed positioning between the connection arm 140 and one or both of the pivot or hinge pin and the attachment portion 110 optionally allows the support portion 120 to hold and maintain position at any given angle and/or one or more selected angles relative to the attachment portion 110.

In the embodiment shown in FIGS. 1-4, both the attachment portion 110 and the support portion 120 are generally octagonal, with eight generally equal-length sides. In other embodiments, one or both of the attachment portion and/or the support portion may be generally circular, square, triangular, or otherwise configured. In yet further embodiments, one or both of the attachment portion and/or the support portion may be another polygonal shape, such as for example hexagonal. In other example embodiments, the attachment portion and the support portion may have different shapes. For example, the attachment portion may be circular and the support portion may be octagonal. In further example embodiments, the attachment portion and/or the support portion may be generally disc shaped.

The example embodiment in FIGS. 1-4 shows a single circular magnet 1150 inlaid within a face of the attachment portion. In other embodiments, the magnet may be another continuous shape that generally follows the perimeter of the multitool or multi-functional accessory, such as an octagon or square. In some embodiments, the magnet may sit on the surface one or more faces of the attachment portion, or it may be positioned completely within the attachment portion. In particular examples, the attachment portion may comprise a plurality of spaced apart magnets. In some embodiments, the support portion may alternatively or additionally comprise one or more magnets as described above.

In example embodiments, the magnetic attraction between the multi-tool accessory and one or both of the case and mobile device is such that the multi-tool accessory remains attached to the mobile device and/or the case when the phone and/or case is otherwise unsupported, with a magnetic attachment force sufficient to support the weight of the mobile device with which the accessory is intended for use, and to resist unintentional detachment in the normal intended use and movement of the device. However, the magnetic attraction is weak enough that the multi-tool accessory may still be separated and detached from the phone and/or case by a user through the application of moderate manual force without damage to the accessory or to the mobile device or case.

In the embodiment shown in FIGS. 1-4, the recessed surface 130 is offset from the center of the attachment portion towards the proximal face containing the magnet 150. This allows the support portion 120 to fit nestingly within the center opening and interior recess of the attachment portion 110 in the closed configuration. In other embodiments, the surface 130 may be located within the midplane of the attachment portion 110 or nearer the distal face opposite that of the magnet 150. In such embodiments, the support portion 120 may not fit entirely within the center of the attachment portion 110. In some embodiments, the support portion may additionally or alternatively comprise a surface with a tab, an opening, or other feature for a user to engage and open the accessory.

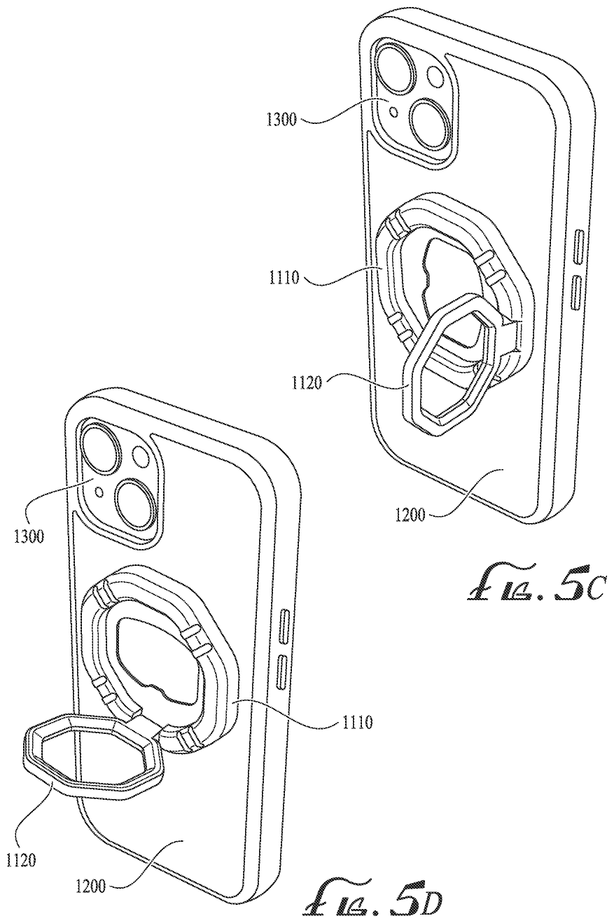

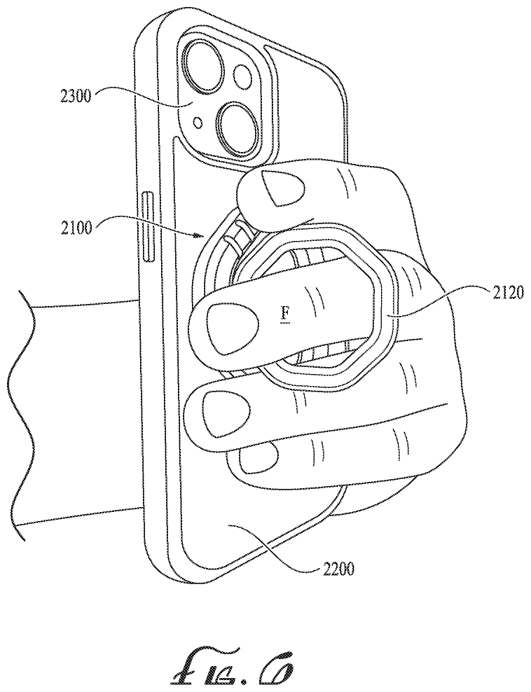

As best shown in FIGS. 5A-5D, the multi-tool accessory 1100 may be placed in different orientations relative to the phone 1300 and case 1200. For example, using relative directions aligned with the page, the multi-tool 1100 may be oriented so that the support portion 1120 opens from a closed or concentric position towards the left side of the multi-tool 1100 and phone 1300, as in FIG. 5A. In other examples, the multi-tool accessory 1100 may be placed so that the support portion 1120 opens towards the top (as in FIG. 5B), towards the right (as in FIG. 5C), or opens towards the bottom (as in FIG. 5D) of the multi-tool 1100 and phone 1300. In yet further embodiments, the multi-tool accessory may be placed such that the support portion 1120 opens at an offset angle to any of the above directions.

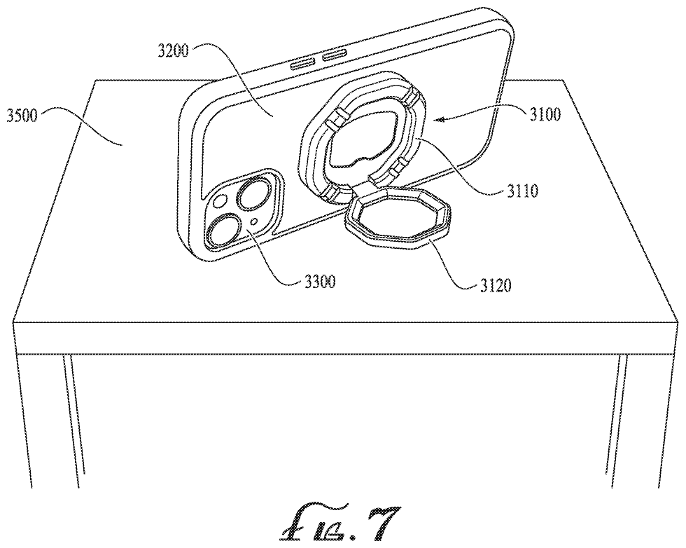

In some embodiments, the multi-tool accessory may be used as a grip for holding the mobile device. For example, as shown in FIG. 6, when the multi-tool 2100 is magnetically attached to a phone 2300 and case 2200, the support portion 2120 may be positioned to be non-concentric with and extending outwardly from the attachment portion 2110. This allows a user to either grip the support portion 2120 and/or place a finger F through the opening in the middle of the support portion 2120 in order to obtain better control over the mobile device 2300. In particular example embodiments, the internal opening through the support portion has a minimum crosswise inner dimension of at least about 20 mm to about 35 mm, for example about 30 mm. In some examples, a user may additionally or alternatively attach a strap or lanyard to the support portion to allow for easy carrying of the mobile device.

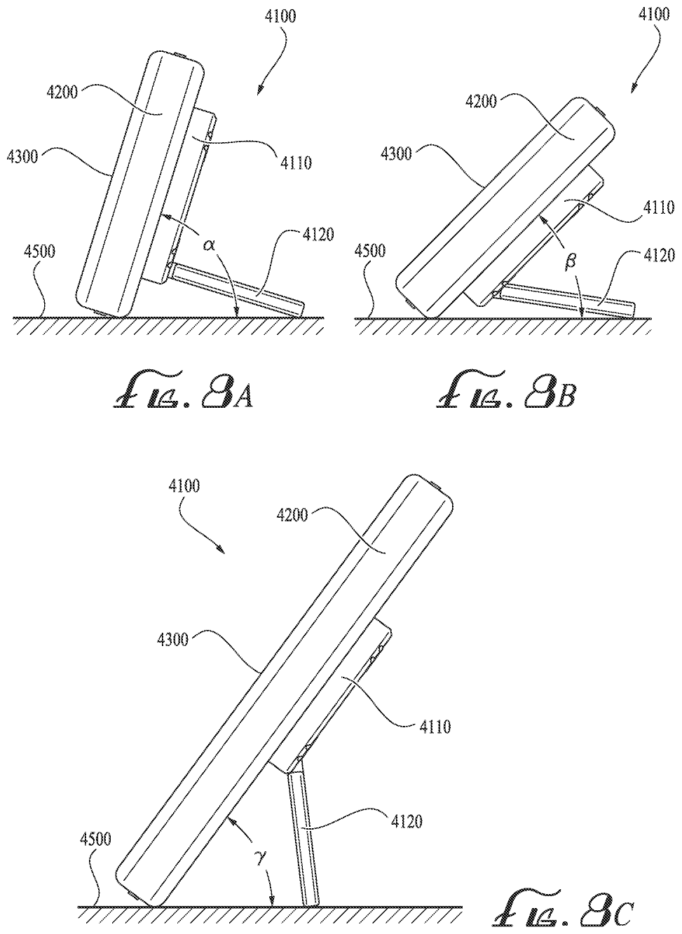

In some examples, the multi-tool or multi-functional accessory may also be used as a stand for a mobile device. In the example embodiment shown in FIG. 7, the attachment portion 3110 of the multi-tool accessory 3100 is magnetically attached to the phone 3300 and/or the case 3200, and the support portion 3120 is positioned such that it is non-concentric with the attachment portion 3110. The mobile device 3300 and case 3200 are placed on their edge on surface 3500 such that the support portion 3120 contacts the surface 3500 so as to provide added stability. The frictional pivot engagement force between the attachment portion 3110 and the support portion 3120 is greater than the weight of the mobile device 3300 and the case 3200, allowing the mobile device 3300 to maintain a desired angle relative to the surface. In the embodiment shown in FIG. 7, the support portion 3120 is octagonal such that a flat edge of its exterior periphery contacts the support surface 3500, adding additional stability as compared to a circular support element.

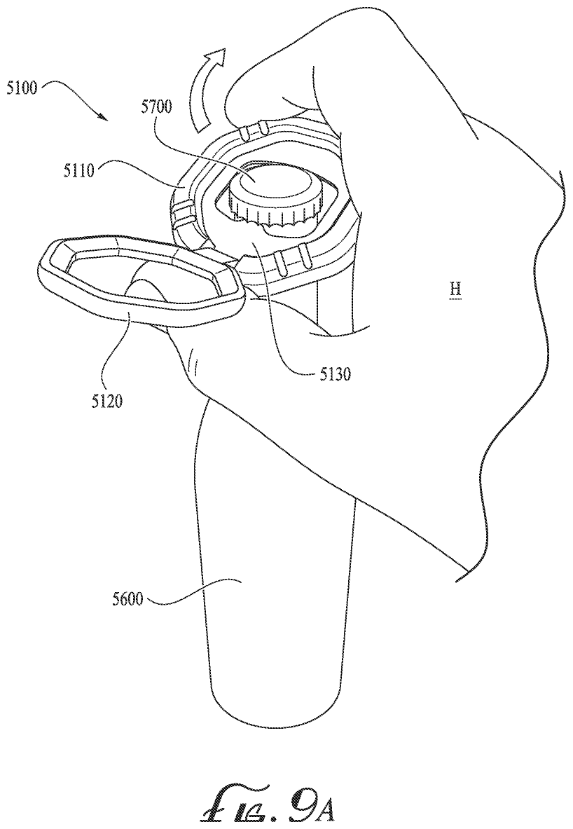

When using the multi-tool or multi-functional accessory as a stand for a mobile device, the angle between the device and a support surface may be changed by adjusting the positioning and orientation of the multi-tool accessory. For example, in FIG. 8A, the device 4300 is at an angle a relative to the support surface 4500. To adjust the angle, the user may adjust the relative angle between the attachment portion 4110 and the support portion 4120. In the example shown in FIG. 8B, the angle between the attachment portion 4110 and the support portion 4120 is reduced, which in turn reduces the relative angle between the device 4300 and the support surface 4500 to the angle B. In the embodiments shown in FIG. 8A-B, the mobile device is supported by the multi-tool accessory 4100 while in a horizontal or landscape position. The multi-tool accessory 4500 may also support the mobile device 4300 in a vertical or portrait orientation, as shown in FIG. 8C.

In the embodiments shown in FIGS. 7 and 8, the multi-tool or multi-functional accessory is oriented relative to the mobile device such that the support portion opens towards the support surface. In other embodiments, the multi-tool accessory may be used as a stand when the multi-tool is at a different orientation relative to the mobile device, such as the orientations described in FIGS. 5A-5D.

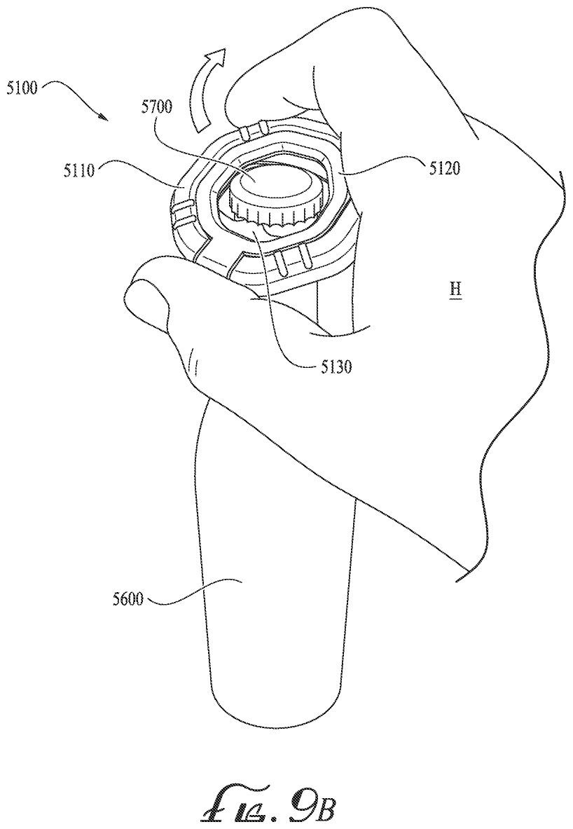

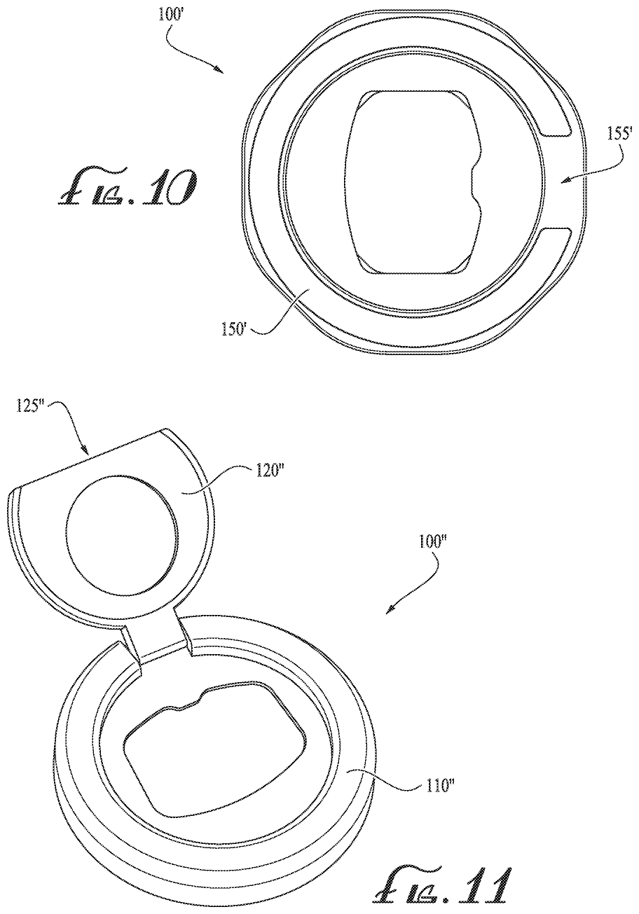

In certain embodiments, the multi-tool or multi-functional accessory may also be used as a bottle opener. For example, in the embodiment shown in FIG. 9A, the multi-tool accessory 5100 may be removed from a mobile device and/or case and placed such that tab or flange portion of the surface 5130 extends between the lip of the opening of the bottle 5600 and the bottle cap 5700. The portion of the surface 5130 opposite the tab is placed on top of the bottle cap 5700, such that the bottle cap is generally within the opening or slot of surface 5130. In example embodiments, the opening or slot in the surface 5130 may be, for example, between about 25-35 mm wide by about 15-25 mm long, or more particularly about 30 mm wide by about 22 mm long; and the tab or flange may be about 5 mm wide by about 1-2 mm long. When a user's hand H applies an appropriate twisting or prying force to the multi-tool 5100 as indicated by the directional arrows, the bottle cap 5700 is separated from the bottle 5600 to open the bottle. In the example shown in FIG. 9A, the multi-tool 5100 is in an open configuration to remove the bottle cap 5700 from the bottle 5600. In the embodiment shown in FIG. 9B, the multi-tool is used to remove the bottle cap 5700 from the bottle 5600 while in the closed configuration.

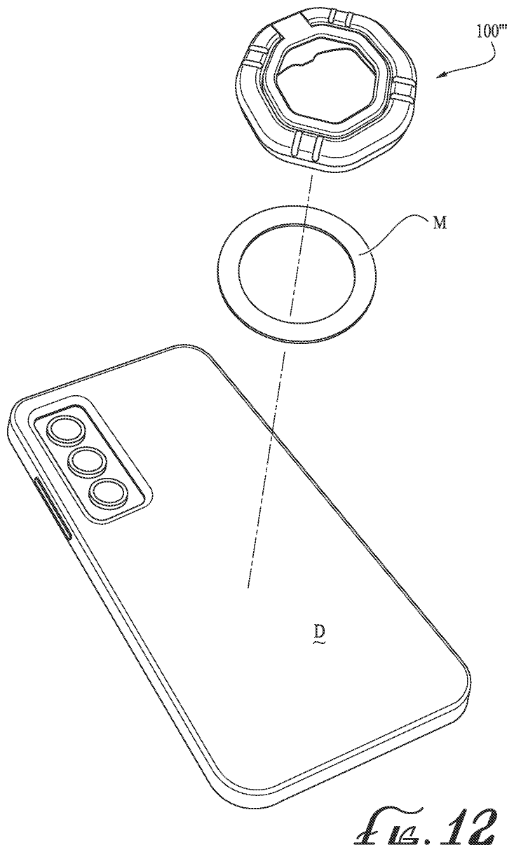

FIG. 11 shows an alternate embodiment of a multi-tool or multi-functional accessory 100′, wherein the attachment portion 110″ has a generally circular inner recessed area configured to receive a hingedly or pivotally attached support portion 120″ that is generally circular, with one or more flat portions 125″ for resting on a support surface in a stand configuration of use.

FIG. 12 is an assembly view showing another alternate embodiment of a multi-tool or multi-functional accessory 100″, wherein the accessory is configured for removable attachment to a mobile phone or other device D by means of a separate magnetic sticker M, configured for magnetic and/or adhesive attachment between the accessory and the device.

While the invention has been described with reference to example embodiments, it will be understood by those skilled in the art that a variety of modifications, additions and deletions are within the scope of the invention, as defined by the following claims.

What is claimed is:

1. A multi-functional accessory for a mobile device, the multi-functional accessory comprising:
an attachment portion configured for removable attachment to the mobile device;
a support portion pivotally coupled with the attachment portion; and
a bottle opener portion.

2. The multi-functional accessory of claim 1, wherein the bottle opener portion comprises a slot formed in the attachment portion.

3. The multi-functional accessory of claim 1, wherein the attachment portion comprises at least one magnetic element configured for releasable engagement with at least one cooperating magnetic element of the mobile device.

4. The multi-functional accessory of claim 3, wherein the at least one magnetic element of the attachment portion comprises a full circular magnetic array.

5. The multi-functional accessory of claim 3, wherein the at least one magnetic element of the attachment portion comprises a C-shaped magnetic array.

6. The multi-functional accessory of claim 3, wherein the at least one magnetic element of the attachment portion comprises a magnetic sticker.

7. The multi-functional accessory of claim 1, wherein the support portion comprises a generally annular body having an internal opening with a minimum crosswise dimension of at least about 20 mm to allow insertion of a user's finger therethough.

8. The multi-functional accessory of claim 1, wherein the support portion comprises a polygonal external periphery.

9. The multi-functional accessory of claim 8, wherein the polygonal external periphery of the support portion is octagonal.

10. The multi-functional accessory of claim 1, wherein the support portion comprises a generally circular body having at least one flat segment.

11. The multi-functional accessory of claim 1, wherein the support portion is pivotally coupled with the attachment portion by a hinged coupling providing a range of pivotal motion spanning at least 0° through 90° between the support portion and the attachment portion from a closed configuration to an open configuration.

12. The multi-functional accessory of claim 11, wherein the hinged coupling has a range of pivotal motion spanning through at least 130° in the open configuration.

13. The multi-functional accessory of claim 1, wherein the attachment portion comprises a recess configured to receive the support portion therein in a closed configuration.

14. The multi-functional accessory of claim 1, wherein the mobile device is selected from a mobile phone, a tablet computer, and a case for a mobile phone or tablet computer.

15. The multi-functional accessory of claim 14, wherein the multi-functional accessory supports the mobile device in both a portrait orientation and a landscape orientation.

16. A multi-functional accessory for a mobile device, the multi-functional accessory comprising:
an attachment portion configured for removable magnetic attachment to the mobile device, and comprising a magnetic array extending substantially continuously 360° around a base surface of the attachment portion without any non-magnetic sections;
a support portion pivotally coupled with the attachment portion.

17. The multi-functional accessory of claim 16, wherein the attachment portion further comprises a bottle opener portion configured for removing a cap from a bottle.

18. The multi-functional accessory of claim 16, wherein the support portion comprises a generally annular body having an internal opening with a minimum crosswise dimension of at least about 20 mm to allow insertion of a user's finger therethough.

19. The multi-functional accessory of claim 16, wherein the support portion comprises a polygonal external periphery.

20. The multi-functional accessory of claim 19, wherein the polygonal external periphery of the support portion is octagonal.

21. The multi-functional accessory of claim 16, wherein the support portion is pivotally coupled with the attachment portion by a hinged coupling providing a range of pivotal motion spanning at least 0° through 90° between the support portion and the attachment portion from a closed configuration to an open configuration.

22. The multi-functional accessory of claim 21, wherein the hinged coupling has a range of pivotal motion spanning through at least 130° in the open configuration.

23. The multi-functional accessory of claim 16, wherein the attachment portion comprises a recess configured to receive the support portion therein in a closed configuration.

24. The multi-functional accessory of claim 16, wherein the mobile device is selected from a mobile phone, a tablet computer, and a case for a mobile phone or tablet computer.

25. The multi-functional accessory of claim 24, wherein the multi-functional accessory supports the mobile device in both a portrait orientation and a landscape orientation.

26. The multi-functional accessory of claim 16, wherein the magnetic array comprises a magnetic sticker.

27. A multi-functional accessory for a mobile device, the multi-functional accessory comprising:
an attachment portion configured for removable attachment to the mobile device; and
a support portion pivotally coupled with the attachment portion, the support portion comprising a polygonal external periphery.

28. The multi-functional accessory of claim 27, wherein the polygonal external periphery of the support portion is octagonal.

29. The multi-functional accessory of claim 27, wherein the support portion further comprises an internal opening with a minimum crosswise dimension of at least about 20 mm to allow insertion of a user's finger therethough.

30. The multi-functional accessory of claim 27, wherein the attachment portion further comprises a bottle opener portion configured for removing a cap from a bottle.

31. The multi-functional accessory of claim 27, wherein the attachment portion comprises at least one magnetic element configured for releasable engagement with a cooperating at least one magnetic element of the mobile device.

32. The multi-functional accessory of claim 31, wherein the at least one magnetic element of the attachment portion comprises a full circular magnetic array.

33. The multi-functional accessory of claim 31, wherein the at least one magnetic element of the attachment portion comprises a C-shaped magnetic array.

34. The multi-functional accessory of claim 31, wherein the at least one magnetic element of the attachment portion comprises a magnetic sticker.

35. The multi-functional accessory of claim 27, wherein the support portion is pivotally coupled with the attachment portion by a hinged coupling providing a range of pivotal motion spanning at least 0° through 90° between the support portion and the attachment portion from a closed configuration to an open configuration.

36. The multi-functional accessory of claim 35, wherein the hinged coupling has a range of pivotal motion spanning through at least 130° in the open configuration.

37. The multi-functional accessory of claim 27, wherein the attachment portion comprises a recess configured to receive the support portion therein in a closed configuration.

38. The multi-functional accessory of claim 27, wherein the mobile device is selected from a mobile phone, a tablet computer, and a case for a mobile phone or tablet computer.

39. The multi-functional accessory of claim 32, wherein the multi-functional accessory supports the mobile device in both a portrait orientation and a landscape orientation.
